(19) United States
(12) Patent Application Publication
(10) Pub. No.: US 2015/0229427 A1
(43) Pub. Date: Aug. 13, 2015

(54) NOISE POWER ESTIMATION METHOD AND APPARATUS

(71) Applicants: Wei WANG, Beijing (CN); Ruiqi ZHANG, Beijing (CN)

(72) Inventors: Wei Wang, Beijing (CN); Ruiqi Zhang, Beijing (CN)

(21) Appl. No.: 14/430,094

(22) PCT Filed: Sep. 20, 2012
(86) PCT No.: PCT/CN2012/001286

§ 371 Date: Mar. 20, 2015

(51) Int. Cl. H04J 11/00; H04W 52/02; H04L 1/16; H04L 5/00

(52) U.S. Cl. CPC H04J 11/0036; H04L 5/0007; H04L 5/0048; H04W 52/0238; H04L 1/1671; H04L 5/0055

(57) ABSTRACT

A method (10) of noise power estimation for PUCCH format 1/1a/1b in LTE system is provided which comprises: determining (11) at least one unused orthogonal cover code, OCC for data symbols and reference symbols in the PUCCH, and estimating (12) noise power by employing the at least one unused OCC, for Signal-Noise Ratio, SNR, calculation and Discontinuous Transmission, DTX, detection. Also, an apparatus of noise power estimation for PUCCH format 1/1a/1b in LTE system is provided. The performance of the noise estimation may be greatly improved, and thus enhancing PUCCH detection accuracy, especially in case of a large number of users in the network.

### TECHNICAL FIELD

The invention generally relates to uplink control signaling transmission for Long Term Evolution (LTE) system, particularly to noise power estimation method and apparatus for Physical Uplink Control Channel (PUCCH) format 1/1a/1b.

### BACKGROUND

In LTE system, Uplink (UL) control signal is transmitted by two approaches.

First, the UL control signal is transmitted on Physical Uplink Shared Channel (PUSCH) when there is PUSCH scheduled on current subframe. In this case, the UL control signal will be multiplexed with UL-SCH data before Discrete Fourier Transform (DFT) operation to reduce the Cubic Metric (CM) for keeping single carrier property. This approach is called Uplink Control Information (UCI) on PUSCH.

Second, the UL control signal is transmitted on PUCCH channel when there is no PUSCH scheduled on current subframe. The PUCCH channel supports a number of formats, so that it may carry different types of control information, including hybrid-ARQ acknowledgement (HARQ-ACK), Channel-State Indicator and Scheduling Request.

In principle, the eNodeB knows when to expect, for example, a HARQ-ACK from the terminal and may therefore perform appropriate demodulation of the acknowledgement on PUCCH. However, there is a certain probability that the terminal has missed the scheduling assignment on the Physical Downlink Control Channel (PDCCH), in which case the eNodeB will expect a HARQ-ACK while the terminal may not transmit one.

To deal with a possibly missed PDCCH assignment (e.g., presence/absence of HARQ-ACK) 3GPP requires, for example, the HARQ-ACK false alarm detection probability as well as the HARQ-ACK missed detection probability. This requirement poses a task to perform Discontinuous Transmission (DTX) detection on hybrid-ARQ acknowledgements, which is not a trivial challenge. Noise power estimation plays an importance role in HARQ-ACK false alarm detection for PUCCH in many applications, e.g. the power of detected signal exceeding the threshold, which is denoted as the multiplication of noise power and a constant value, is considered as presence of ACK or NACK. Hence, the accuracy of noise power estimation directly impacts the detection performance of PUCCH format 1/1a/1b.

In many applications for PUCCH noise estimation, it only uses free cyclic shifts for noise estimation. The cyclic shifts will be assigned to different user in order to retain orthogonality between users. In case of a large number of users in the network, the number of free cyclic shifts becomes insufficient, even none. The less number of free cyclic shifts is available, the worse performance will be achieved for noise estimation. Once there is no free cyclic shift, the noise estimation cannot be accomplished.

### SUMMARY

This disclosure aims to provide a noise estimation method and apparatus, for example, when the Scheduling Request (SR) or ACK/NACK of multiple users are multiplexed on the same Physical Resource Block (PRB), thus preferably mitigate, alleviate or eliminate one or more of the above mentioned disadvantages singly or in any combination.

In a first aspect of the invention, there is provided a method of noise power estimation for PUCCH format 1/1a/1b in LTE system, including: determining at least one unused orthogonal cover code, OCC for data symbols and reference symbols in the PUCCH, and estimating noise power by employing the at least one unused OCC, for Signal-Noise Ratio, SNR, calculation and Discontinuous Transmission, DTX, detection.

In an embodiment, the at least one OCC may comprise an unused orthogonal cover [−1 −1 +1 +1] for data symbols in the PUCCH.

In an embodiment, noise power is estimated by employing said at least one unused OCC in combination with at least one free cyclic shift.

In an embodiment, estimating noise power may comprise removing Zadoff-Chu (ZC) sequence from a received PUCCH frequency signal to obtain data symbols and reference symbols; and the obtained data symbols and reference symbols is de-spread using said at least one unused OCC.

In an embodiment, the noise power is estimated in association with number of unused OCCs for the data symbols and number of unused OCCs for reference symbols.

In an embodiment, the noise power may be derived according to following formula:

$$\tilde{n} ( a ) = \frac{{\sum }_{{i}_{ds\_free}} ( {\sum }_{k} {\vert {{n}_{ds} ( k )}_{{i}_{ds\_free} , a} \vert}^{2} / 4 ) + {\sum }_{{i}_{r s\_free}} ( {\sum }_{k} {\vert {{n}_{rs} ( k )}_{{i}_{r s\_free} , a} \vert}^{2} / 3 )}{( {i}_{ds\_free} + {I}_{rs\_free} ) / {N}_{sc}^{RB}}$$

where Ids_free and Irs_free are the number of the unused OCCs for data symbols and reference symbols respectively; i_{ds}_{_{—}}_{free} and iᵣₛ_{_{—}}_{free} denote the unused OCC index for data symbol and reference symbol respectively; a is an index of a receive antenna; k is an index of a subcarrier, k=0, 1, . . . , N_{sc}^{RB}−1 and N_{sc}^{RB} is the number of subcarrier in one RB; and

$${{n}_{ds} ( k )}_{{i}_{ds\_free} , a} and {{n}_{rs} ( k )}_{{i}_{r s\_free} , a}$$

represent noise signals after de-spreading for data symbol and reference symbol respectively.

In a second aspect of the invention, there is provided an apparatus for noise power estimation for PUCCH format 1/1a/1b in LTE system, comprising: a determination module configured to determine at least one unused orthogonal cover code, OCC for data symbols and reference symbols in the PUCCH, and an estimation module configured to estimate noise power by employing the at least one unused OCC for Signal-Noise Ratio, SNR, calculation and Discontinuous Transmission, DTX, detection.

In an embodiment, the estimation module may be configured to employ an unused orthogonal cover [−1 −1 +1 +1] for data symbols in the PUCCH to estimate noise power.

In an embodiment, the estimation module may be configured to employ the at least one unused OCC in combination with at least one free cyclic shift to estimate noise power.

In an embodiment, the estimation module may be configured to obtain data symbols and reference symbols by removing Zadoff-Chu (ZC) sequence from a received PUCCH frequency signal; and de-spread the data symbols and reference symbols using unused the at least an unused OCC.

In a third aspect of the invention, there is provided a base station comprising the apparatus of the embodiments of the invention. Preferably, the base station is an eNodeB device.

In a fourth aspect of the invention, there is provided a computer program product comprising a set of computer executable instructions stored on a computer readable medium, when executed, to implement the methods of the embodiments of the invention.

In a fifth aspect of the invention, there is provided a computer-readable medium having stored thereon a computer program product comprising a set of computer executable instructions which when executed by a processor in a computing device, causes the computing device to implement the method of the embodiments of the invention.

In various aspects of the invention, the performance of the noise estimation may be greatly improved, and thus enhancing PUCCH detection accuracy, especially in case of a large number of users in the network. In this way, the base station (e.g., eNodeB) thus performs the appropriate demodulation of the acknowledgement on PUCCH.

### BRIEF DESCRIPTION OF THE DRAWINGS

The features and advantageous of the present invention will be more apparent from the following exemplary embodiments of the invention illustrated with reference to the accompanied drawings, in which:

FIG. 1 illustrates a schematic flowchart of a method of noise power estimation for PUCCH format 1/1a/1b in LTE system according to an embodiment of the invention;

FIG. 2 illustrates a schematic structural diagram of an apparatus for noise power estimation for PUCCH format 1/1a/1b in LTE system according to an embodiment of the present invention;

FIG. 3 illustrates an exemplary schematic cumulative distribution function (CDF) curve for estimated noise power with one user in the network;

FIG. 4 illustrates an exemplary schematic cumulative distribution function (CDF) curve for estimated noise power with six users in the network;

FIG. 5 illustrates an exemplary schematic plot of the cumulative distribution function (CDF) curve for estimated noise power with ten users in the network;

FIG. 6 illustrates an exemplary schematic plot of the block error rate (BLER) for PUCCH format 1a with one user in the network; and

FIG. 7 illustrates an exemplary schematic plot of the block error rate (BLER) for PUCCH format 1a with six users in the network.

### DETAILED DESCRIPTION

Embodiments of the invention will be described thoroughly hereinafter with reference to the accompanied drawings. It will be apparent to those skilled in the art that the invention may, however, be embodied in many different forms and should not be construed as limited to the embodiments and specific details set forth herein. Like numbers refer to like elements throughout the description.

In this disclosure, although specific terminologies have been used to exemplify the invention, this should not be seen as limiting the scope of the invention to only the aforementioned communication system. With the rapid development in communications, there will of course also be future type of technologies and systems with which the present invention may be adapted.

In the context of the invention, terms “orthogonal cover”, “orthogonal cover code”, “OCC”, and “orthogonal sequence”, etc. all refer to the same meaning as known in the art.

The orthogonal cover is used in PUCCH for both data and reference signal (RS). In the disclosure, the noise power is estimated by employing unused or free OCCs which are orthogonal to those used OCCs. Considering there are 4 data symbols in one slot but only 3 OCCs specified in LTE specification, there is always one OCC is free for PUCCH data symbols even with a large number of users. This free OCC together with other possible free OCCs can be used for noise estimation. It may solve the problem of existing solutions that cyclic shifts will be exhausted in case of a large number of users.

The physical uplink control channel (PUCCH) may carry uplink control information. The physical uplink control channel (PUCCH) supports multiple formats in LTE system. For PUCCH format 1/1a/1b in LTE system, the estimated noise power is used for signal noise rate (SNR) calculation and/or DTX detection. Usually, the noise covariance is estimated per physical resource block (PRB), slot and antenna, and common for all users in that PRB. With the configuration of normal cyclic prefix (CP) length, the length-4 and length-3 orthogonal cover sequences are designed for PUCCH data symbol and reference symbol, separately. Multiple users may transmit data symbols on the same time-frequency resource and be separated through different cyclic shifts and orthogonal covers with length-4. To be able to estimate the channels for the respective users, the reference signals employ cyclic shifts and orthogonal cover sequences with length-3 as well. Table 1 and 2 below summarize the orthogonal covers used respectively by data and reference signal conventionally.

TABLE 1
orthogonal cover for data

| Sequence index | Orthogonal sequences |
|---|---|
| 0 | [+1 +1 +1 +1] |
| 1 | [+1 −1 +1 −1] |
| 2 | [+1 −1 −1 +1] |

TABLE 2
orthogonal cover for reference signal

| Sequence index | Orthogonal sequences |
|---|---|
| 0 | [1 1 1] |
| 1 | [1 e^{j2π/3} e^{j4π/3}] |
| 2 | [1 e^{j4π/3} e^{j2π/3}] |

From the tables above, only three orthogonal covers are used for data and reference signals, respectively. However, since the length of orthogonal cover on data symbol is 4, there will be 4 vectors that are orthogonal with each other. Considering three orthogonal covers defined as in above table 1 are used, there will be another free orthogonal cover [−1 −1 +1 +1] which is always not used by any users. It is to be noted that the orthogonal sequence [1 1 −1 −1], with opposite sign to the orthogonal sequence [−1 1 +1 +1], is also orthogonal with the defined orthogonal covers on data symbol. But considering from the dispreading or correlation, there is no any difference between the orthogonal sequence [−1 −1 +1 +1] and [1 1 −1 −1].

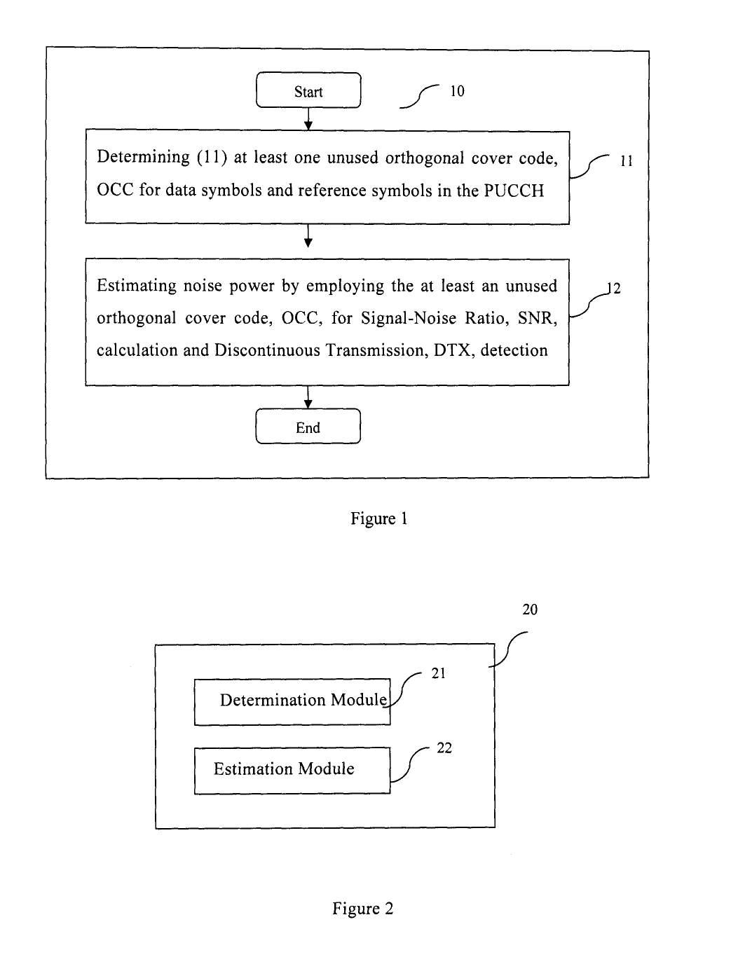

FIG. 1 shows a schematic flowchart of a method of noise power estimation for PUCCH format 1/1a/1b in LTE system.

In the method, first, an unused orthogonal cover code (OCC) may be determined for data symbols and reference symbols in the PUCCH. It is to be noted the unused or free OCC may include one or more OCCs that are not used for data symbols or reference symbols.

In particular, in an embodiment, the always unused or free orthogonal cover sequence [−1 −1 +1 +1] may always be used for the noise power estimation with different users in the network, especially in case of a large number of users in the network. In another embodiment, the noise power may also be calculated based on the determined one or more other free OCC(s) for data and/or RS, which are not assigned to any users. In yet another embodiment, the determined unused OCC(s) may also be used in combination with at least one free cyclic shift for estimating noise power.

Second, the noise power may be estimated by employing the unused OCC(s), and thus used for Signal-Noise Ratio, SNR, calculation and Discontinuous Transmission, DTX, detection.

It is to be noted that the accuracy of noise power estimation may be associated with the number of unused OCCs for the data symbols and the number of unused OCCs for reference symbols. The more unused or free OCCs are used for noise power estimation, the better performance of DTX detection will be obtained.

For example, in an embodiment, assuming the received PUCCH signal in one target resource block (RB) in one slot is represented as

$${\tilde{R}}_{l , a} ( k ) ,$$

where l denotes the OFDM symbol, l=0, 1, . . . , 6 for normal CP length; a is an index of a receive antenna; and k is the index of subcarrier. The ZC sequence for the u^{th} user is represented as

$${{ZC}_{u}}_{l} ( k ) .$$

For the first step, Zadoff-Chu sequence may be removed from a received PUCCH frequency signal to obtain the resultant data symbols and reference symbols.

In particular, ZC sequence is removed in frequency domain according to equation (1) to obtain a resultant symbol

$${CS ( k )}_{l , a} .$$

$${CS ( k )}_{l , a} = {\tilde{R}}_{l , a} ( k ) \cdot {{ZC}_{u}^{*}}_{ns} ( k ) \qquad ( 1 )$$

The data symbol may be denoted as equation (2):

$${CS}_{{ds}_{{l}^{′} , a}} ( k ) = {CS ( k )}_{l , a} ,$$

where and lε[0, 1, 5, 6], and l′=0, 1, 2, 3 (2)

The reference symbol may be denoted as equation (3):

$${CS}_{{rs}_{{l}^{″} , a}} ( k ) = {CS ( k )}_{l , a} ,$$

where lε[234], and l″=0, 1, 2 (3)

For the second step, the resultant data symbols and reference symbols are de-spread using said at least one unused OCC.

In particular, OCC(s) that is not used by any user may be defined as w_{ds} (i_{ds}_{_{—}}_{free}, l′) for data symbols and wᵣₛ(iᵣₛ_{_{—}}_{free}, l″) for reference symbols, where l′=0, 1, 2, 3 and l″=0, 1, 2 denote the symbol index. i_{ds}_{_{—}}_{free} and iᵣₛ_{_{—}}_{free} denote the unused OCC index for data symbol and reference symbol respectively. It should be noted that w_{ds} (i_{ds}_{_{—}}_{free}, l′)=[−1 −1 +1 +1] for i_{ds}_{_{—}}_{free}=3 is always free for noise estimation.

The frequency signal is de-spread using the unused OCC(s), then all the samples after de-spreading are noise, which may be denoted as equations (4) and (5):

$$\begin{matrix}{{n}_{ds} ( k )}_{{i}_{ds\_free} , a} = {\sum }_{{l}^{′}} {CS}_{{ds}_{{l}^{′} , a}} ( k ) \cdot {w}_{ds}^{*} ( {i}_{ds\_free} , {l}^{′} ) & ( 4 ) \\ {{n}_{rs} ( k )}_{{i}_{r s\_free} , a} = {\sum }_{{l}^{″}} {CS}_{{rs}_{{l}^{″} , a}} ( k ) \cdot {w}_{rs}^{*} ( {i}_{r s\_free} , {l}^{″} ) & ( 5 )\end{matrix}$$

With these noise samples, the final noise power may be derived as equation (6) as below.

$$\tilde{n} ( a ) = \frac{{\sum }_{{i}_{ds\_free}} ( {\sum }_{k} {\vert {{n}_{ds} ( k )}_{{i}_{ds\_free} , a} \vert}^{2} / 4 ) + {\sum }_{{i}_{r s\_free}} ( {\sum }_{k} {\vert {{n}_{rs} ( k )}_{{i}_{r s\_free} , a} \vert}^{2} / 3 )}{( {I}_{ds\_free} + {I}_{rs\_free} ) / {N}_{sc}^{RB}} \qquad ( 6 )$$

Where I_{ds}_{_{—}}_{free} and Iᵣₛ_{_{—}}_{free} are the number of free OCC(s) for data symbols and reference symbols respectively.

According to the embodiments, the noise power could always be derived in an improved way, and thus DTX detection will be performed more precisely, and eNodeB can therefore perform the appropriate demodulation of the acknowledgement on PUCCH.

FIG. 2 illustrates a schematic block diagram of an apparatus 20 for noise power estimation for PUCCH format 1/1a/1b in LTE system.

The apparatus 20 includes a determination module 21 for determining one or more unused orthogonal cover codes (OCCs) for data symbols and reference symbols in the PUCCH. The apparatus may also include an estimation module 22 for estimating noise power by employing the one or more unused OCC(s) for Signal-Noise Ratio (SNR) calculation and/or Discontinuous Transmission (DTX) detection.

Preferably, to estimate the noise power, the estimation module 22 may employ the unused orthogonal cover [−1 −1 +1 +1] for data symbols in the PUCCH. Alternatively, the estimation module 22 may also employ one or more unused or free OCCs including the unused orthogonal cover [−1 −1 +1 +1] in combination with free cyclic shift(s).

In the embodiment, the estimation module 22 may remove Zadoff-Chu (ZC) sequence from a received PUCCH frequency signal so as to obtain resultant data symbols and reference symbols; and de-spread the resultant data symbols and reference symbols using the at least one unused OCC to obtain the resultant noise power.

It is to be noted that the accuracy of noise power estimation may be associated with the number of unused OCCs for the data symbols and the number of unused OCCs for reference symbols. The more unused or free OCCs are used for noise power estimation, the better performance of DTX detection will be obtained.

In another embodiment, a base station is provided. The base station comprises the apparatus 20.

According to the embodiments above, the performance of noise power estimation and thus the DTX detection will be improved.

In this disclosure, a comparison of performance for noise estimation is provided between the embodiments of the invention and the existing solution for the cases with 1 user, 6 users and 10 users, respectively. The simulation parameters are as follows.

TABLE 3
simulation parameter configuration

| Simulation parameters | values |
|---|---|
| Standard | 3GPP LTE Release 8 |
| Carrier frequency | 2.6 GHz |
| Physical channel | PUSCH |
| System bandwidth | 20 MHz |
| Doppler frequency | 5 Hz |
| Number of sub-carriers per RB | 12 |
| Number of RBs allocated to the user | 1 |
| Number of antennas at the eNodeB | 8 |
| Channel Model | EPA |

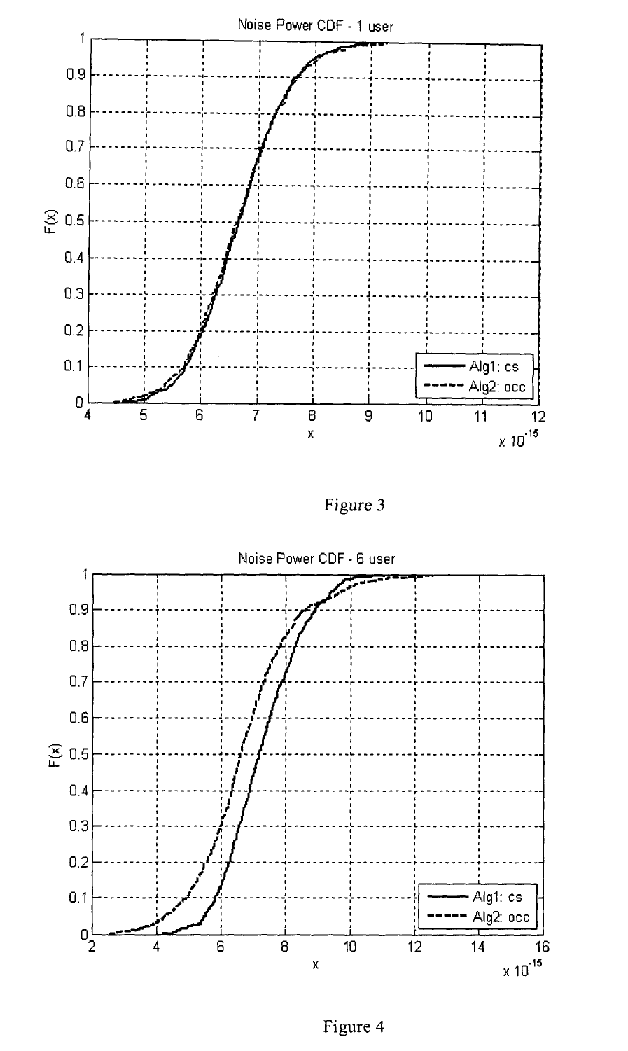

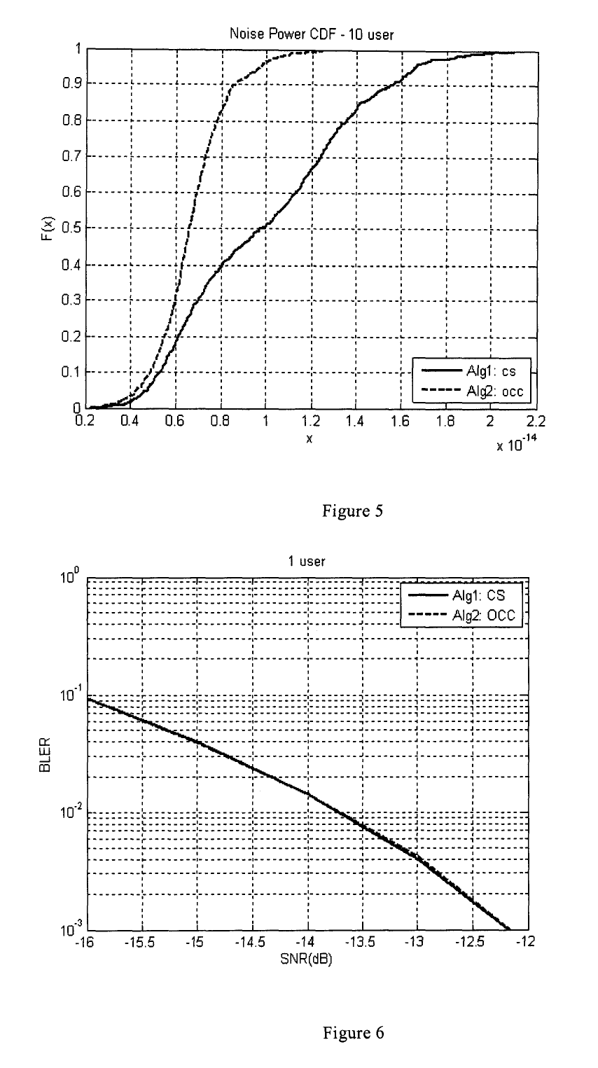

Simulation results are provided in FIGS. 3-7. The curve with legend ‘Alg1: CS’ denotes the performance of existing solution, and the curve with legend ‘Alg2: OCC’ denotes the performance of the embodiments of the invention.

FIGS. 3 to 5 illustrate the cumulative distribution function (CDF) curve for estimated noise power for the case with different number of users. It can be found that for the case with single user, the estimated noise power by embodiments of the invention is almost the same as that by existing solution, which is aligned with the actual noise power added in the simulation. However, along with the increase of the number of users (e.g., 6 users and 10 users), the estimated noise power (represented by solid lines) by existing solution changes more rapidly away from the actual noise power value than that (represented by dotted lines) in the embodiments of the invention.

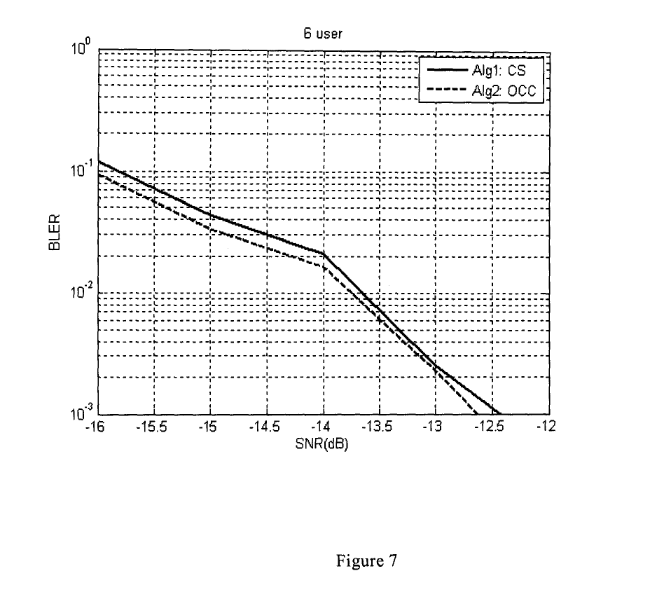

To evaluate the estimated noise power impact on PUCCH detection performance, secondly, the block error rate (BLER) for PUCCH format 1a is plotted for the case with different number of users in FIGS. 6 to 7.

From FIG. 6 (i.e., 1 users) and FIG. 7 (i.e., 6 users), the performance of existing solution using free cyclic shifts (e.g. curve with solid line) for noise estimation degrades rapidly along with the number of users increasing, especially when the number of users is large (for example, 6 users in FIG. 7). However, the performance of this disclosure using free orthogonal covers (e.g., curve with dotted line) for noise estimation degrades slowly along with the number of users increasing (for example, 6 users in FIG. 7). Even with large number of users, the performance remains stable since there is always one free orthogonal cover left.

It will be appreciated that the above description for clarity has described the embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

It is to be noted that, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Further, it is to be noted that, the order of features/steps in the claims or in the description do not imply any specific order in which the features/steps must be worked. Rather, the steps/features may be performed in any suitable order.

The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and/or functionally distributed between different units and processors.

The terminology used herein is for the purpose of describing particular embodiments only and is not intended to limit to the invention. As used herein, the singular forms “a”, “an” and “the” are intended to comprise the plural forms as well, unless otherwise stated. It will be further understood that the terms “including”, “comprising” and conjugation thereof when used herein, specify the presence of stated features, integers, steps, operations, elements, and/or components, but do not preclude the presence or addition of one or more other features, integers, steps, operations, elements, components, and/or groups thereof.

Although the invention has been particularly shown and described with reference to exemplary embodiments thereof, it will be understood by those skilled in the art that various changes in form and details may be made without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims.

1. A method of noise power estimation for PUCCH format 1/1a/1b in LTE system, comprising:
Determining at least one unused orthogonal cover code, OCC for data symbols and reference symbols in the PUCCH,
Estimating noise power by employing the at least one unused OCC, for Signal-Noise Ratio, SNR, calculation and Discontinuous Transmission, DTX, detection.

2. The method of claim 1, wherein said at least one OCC comprises an unused orthogonal cover [−1 −1 +1 +1] for data symbols in the PUCCH.

3. The method of claim 1, wherein estimating noise power comprises estimating noise power by employing said at least one unused OCC in combination with at least one free cyclic shift.

4. The method of claim 1, wherein estimating noise power comprises:
obtaining data symbols and reference symbols by removing Zadoff-Chu sequence from a received PUCCH frequency signal; and de-spreading the data symbols and reference symbols using said at least one unused OCC.

5. The method of claim 4, wherein the noise power is estimated in association with number of unused OCCs for the data symbols and number of unused OCCs for reference symbols.

6. The method of claim 5, wherein the noise power is derived according to following formula:
$$\tilde{n} ( a ) = \frac{{\sum }_{{i}_{ds\_free}} ( {\sum }_{k} {\vert {{n}_{ds} ( k )}_{{i}_{ds\_free} , a} \vert}^{2} / 4 ) + {\sum }_{{i}_{r s\_free}} ( {\sum }_{k} {\vert {{n}_{rs} ( k )}_{{i}_{r s\_free} , a} \vert}^{2} / 3 )}{( {I}_{ds\_free} + {I}_{rs\_free} ) / {N}_{sc}^{RB}}$$
where I_{ds}_{_{—}}_{free} and Iᵣₛ_{_{—}}_{free} are the number of the unused OCCs for data symbols and reference symbols respectively; i_{ds}_{_{—}}_{free} and iᵣₛ_{_{—}}_{free} denote the unused OCC index for data symbol and reference symbol respectively; a is an index of a receive antenna; k is an index of a subcarrier, k=0, 1, . . . , N_{sc}^{RB}−1 and N_{sc}^{RB} is the number of subcarrier in one RB; and
$${{n}_{ds} ( k )}_{{i}_{ds\_free} , a} and {{n}_{rs} ( k )}_{{i}_{r s\_free} , a}$$
represent noise signals after de-spreading for data symbol and reference symbol respectively.

7. An apparatus for noise power estimation for PUCCH format 1/1a/1b in LTE system, comprising:
A determination module configured to determine at least one unused orthogonal cover code, OCC for data symbols and reference symbols in the PUCCH, and
An estimation module configured to estimate noise power by employing the at least one unused OCC for Signal-Noise Ratio, SNR, calculation and Discontinuous Transmission, DTX, detection.

8. The apparatus of claim 7, wherein the estimation module is configured to estimate noise power by employing an unused orthogonal cover [−1 −1 +1 +1] for data symbols in the PUCCH.

9. The apparatus of claim 7, wherein the estimation module is configured to estimate noise power by employing the at least one unused OCC in combination with at least one free cyclic shift.

10. The apparatus of claim 7, wherein the estimation module is configured to:
obtain data symbols and reference symbols by removing Zadoff-Chu, ZC, sequence from a received PUCCH frequency signal; and de-spread the data symbols and reference symbols using the at least one unused OCC.

11. The apparatus of claim 7, wherein the noise power is estimated in association with number of unused OCCs for the data symbols and number of unused OCCs for reference symbols.

12. The apparatus of claim 11, wherein the noise power is derived according to following formula:
$$\tilde{n} ( a ) = \frac{{\sum }_{{i}_{ds\_free}} ( {\sum }_{k} {\vert {{n}_{ds} ( k )}_{{i}_{ds\_free} , a} \vert}^{2} / 4 ) + {\sum }_{{i}_{r s\_free}} ( {\sum }_{k} {\vert {{n}_{rs} ( k )}_{{i}_{r s\_free} , a} \vert}^{2} / 3 )}{( {I}_{ds\_free} + {I}_{rs\_free} ) / {N}_{sc}^{RB}}$$
where I_{ds}_{_{—}}_{free} and Iᵣₛ_{_{—}}_{free} are the number of the unused OCCs for data symbols and reference symbols respectively; i_{ds}_{_{—}}_{free} and iᵣₛ_{_{—}}_{free} denote the unused OCC index for data symbol and reference symbol respectively; k is an index of a subcarrier, k=0, 1, . . . , N_{sc}^{RB}−1 and N_{sc}^{RB} is the number of subcarrier in one RB; and
$${{n}_{ds} ( k )}_{{i}_{ds\_free} , a} and {{n}_{rs} ( k )}_{{i}_{r s\_free} , a}$$
represent noise signals after de-spreading for data symbol and reference symbol respectively.

13. The apparatus of claim 7, wherein the apparatus is a base station.

14. (canceled)

15. A non-transient computer-readable medium having stored thereon a computer program product comprising a set of computer executable instructions which when executed by a processor in a computing device, causes the computing device to implement the method according to claim 1.

16. The non-transient computer-readable medium of claim 15, wherein said at least one OCC comprises an unused orthogonal cover [−1 −1 +1 +1] for data symbols in the PUCCH.

17. The non-transient computer-readable medium of claim 15, wherein estimating noise power comprises estimating noise power by employing said at least one unused OCC in combination with at least one free cyclic shift.

18. The non-transient computer-readable medium of claim 15, wherein estimating noise power comprises:
obtaining data symbols and reference symbols by removing Zadoff-Chu sequence from a received PUCCH frequency signal; and de-spreading the data symbols and reference symbols using said at least one unused OCC.

19. The non-transient computer-readable medium of claim 18, wherein the noise power is estimated in association with number of unused OCCs for the data symbols and number of unused OCCs for reference symbols.

20. The non-transient computer-readable medium of claim 19, wherein the noise power is derived according to following formula:
$$\tilde{n} ( a ) = \frac{{\sum }_{{i}_{ds\_free}} ( {\sum }_{k} {\vert {{n}_{ds} ( k )}_{{i}_{ds\_free} , a} \vert}^{2} / 4 ) + {\sum }_{{i}_{r s\_free}} ( {\sum }_{k} {\vert {{n}_{rs} ( k )}_{{i}_{r s\_free} , a} \vert}^{2} / 3 )}{( {I}_{ds\_free} + {I}_{rs\_free} ) / {N}_{sc}^{RB}}$$
where I_{ds}_{_{—}}_{free} and Iᵣₛ_{_{—}}_{free} are the number of the unused OCCs for data symbols and reference symbols respectively; i_{ds}_{_{—}}_{free} and iᵣₛ_{_{—}}_{free} denote the unused OCC index for data symbol and reference symbol respectively; a is an index of a receive antenna; k is an index of a subcarrier, k=0, 1, . . . , N_{sc}^{RB}−1 and N_{sc}^{RB} is the number of subcarrier in one RB; and
$${{n}_{ds} ( k )}_{{i}_{ds\_free} , a} and {{n}_{rs} ( k )}_{{i}_{r s\_free} , a}$$
represent noise signals after de-spreading for data symbol and reference symbol respectively.
